(19) United States
(12) Patent Application Publication
(10) Pub. No.: US 2006/0165868 A1
(43) Pub. Date: Jul. 27, 2006

(54) Method of manufacturing soybean-derived food material and processed food

(76) Inventors: Akira Takaya, Saitama (JP); Tosikazu Ogura, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 10/527,698

(22) PCT Filed: Sep. 11, 2002
(86) PCT No.: PCT/JP02/09253

§ 371 Date: Apr. 11, 2005

(51) Int. Cl. A23L 1/20

(52) U.S. Cl. 426/634

(57) ABSTRACT

An object of the present invention is to provide a method of manufacturing a food material with very little odor, using okara, the majority of which is conventionally discarded, as a raw material. The present invention relates to a method of manufacturing a soybean-derived food material, wherein water-added okara is boiled, and then washed in either cold or warm water.

### TECHNICAL FIELD

The present invention relates to a method of manufacturing soybean-derived food materials using either okara or soybeans as the raw material, and also relates to processed food.

### BACKGROUND ART

Okara is the solid residue or curd lees generated as a by-product during the production of tofu or soymilk from soybeans. Okara is produced in large quantities, and because of its nutritional value, many people have attempted to devise an effective way of utilizing okara. However, improving the peculiar smell, flavor, and texture of okara has proven impossible, and it is currently treated as an industrial waste product, with the annual treatment costs exceeding 10 billion yen.

Okara contains a variety of soybean-derived active ingredients, including soybean saponin, isoflavone, calcium, lecithin, and dietary fiber. Of these ingredients, soybean saponin has been reported to prevent hardening of the arteries and obesity by suppressing lipoperoxidation and accelerating the metabolism of fat, isoflavone has been reported to improve and prevent conditions such as osteoporosis by its function like female hormone activity, and enlargement of the prostate, and to suppress menopause symptoms, and lecithin has been reported to improve and prevent hardening of the arteries by preventing the deposition of cholesterol within the blood vessels, and improve and prevent memory loss and dementia by refining neurotransmitters. Accordingly, okara is potentially very valuable as a health food product. However, due to its peculiar smell and poor palatability, only a very small proportion of okara is used for human consumption. Furthermore, because okara has a high protein content it is prone to turning rancid, making it very difficult to use as a food ingredient within processed foods. As a result, despite its nutritional usefulness, okara is currently not effectively utilized as a food.

### DISCLOSURE OF THE INVENTION

A first object of the present invention is to provide a method of manufacturing a food material with very little odor, using okara, the majority of which is conventionally discarded, as a raw material, thus providing a method of effectively utilizing okara as a food product.

Furthermore, a second object of the present invention is to provide a method of manufacturing a soybean-derived food material with very little odor, using soybeans as a raw material.

Furthermore, a third object of the present invention is to provide a palatable soybean-derived food material that uses okara as a raw material.

In addition, a fourth object of the present invention is to provide a processed food containing a soybean-derived food material with very little odor.

As a result of intensive research into ways of removing the odor from okara, the inventors of the present invention discovered that by as much as removing any residual soymilk ingredients from okara, the characteristic smell associated with okara could be removed, and they were thus able to complete the present invention.

A first aspect of the present invention, aimed at achieving the first object above, relates to a method of manufacturing a soybean-derived food material, wherein water-added okara is boiled, and then washed in either cold or warm water.

A second aspect of the present invention, aimed at achieving the second object above, relates to a method of manufacturing a soybean-derived food material, comprising a swelling step of immersing soybeans in water to swell the soybeans, a water addition step of adding water to the swollen soybeans, a boiling step of boiling the swollen soybeans in the added water, a mashing step of mashing the boiled soybeans, and a washing step of washing the paste produced from the mashed soybeans.

A third aspect of the present invention, aimed at achieving the third object above, relates to a soybean-derived food material, which is formed as fine particles of 20 to 50 microns using either one of the first and second aspects of the invention.

A fourth aspect of the present invention, aimed at achieving the fourth object above, relates to a processed food comprising a soybean-derived food material manufactured according to either one of the first and second aspects of the invention.

### BEST MODE FOR CARRYING OUT THE INVENTION

In a first aspect of the invention, the term “okara” describes the solid residue or curd lees generated following separation of the soymilk from the swollen and mashed soybeans during the production of soybean products such as tofu and soymilk. Typically, okara retains approximately 40 wt % of the soymilk ingredients, although this figure depends on the performance of the okara separation device used. These residual soymilk ingredients are responsible for the characteristic odor of okara. In the present invention, the process described below is used to dramatically reduce the quantity of these residual soymilk ingredients, thereby removing the odor.

The first step of the first aspect of the present invention involves adding water to the okara. The amount of water added to the okara is typically 3 to 10 times, and preferably from 6 to 8 times, the weight of the okara.

The next step of the first aspect of the present invention involves boiling the okara in the added water. The boiling may be conducted either at normal pressure, or under pressurized conditions. Boiling causes the residual soymilk ingredients within the okara to migrate into the water phase. The length of the boiling step is properly set within a range from 5 to 30 minutes.

The next step of the present invention is a step of washing the boiled okara. In an initial stage of the washing step, the boiled okara is preferably dewatered down to a water content of approximately 70 to 85%, in order to remove the soymilk ingredients that have migrated into the water. The washing step may be conducted either in cold water, or in warm water at 20 to 60° C. The washing process is conducted either by performing 2 or more repetitions of a batch washing process, in which the boiled and dewatered okara is combined with a 3 to 5-fold weight excess of water or warm water, or by performing a similar continuous washing process using a continuous washing device.

The soybean-derived food material obtained following the washing process has only a very faint odor, and can be subjected to subsequent treatments as required.

Examples of subsequent treatments include methods for dewatering the washed okara using a dewatering device, and methods for separating the washed okara into a coarse component and a fine component using a separation device. Examples of suitable dewatering device for use in subsequent treatments include roller presses, filter presses, and centrifugal separators. Examples of suitable separation devices for use in subsequent treatments include filtering cloths and electric sieves.

In order to improve the palatability of a soybean-derived food material of the present invention, the material is preferably crushed. This crushing step may be incorporated at any stage during the manufacture of the soybean-derived food material, including crushing of the raw material okara, crushing the washed okara to generate a paste, or crushing the final soybean-derived food material produced following dewatering. Suitable examples of the crushing device include a millstone or an electric grinder. The crushing preferably involves fine grinding to generate fine particles of 20 to 50 microns. If the particles are smaller than 20 microns, then the costs associated with the crushing step increase, whereas if the size exceeds 50 microns, then there is an undesirable fall in the palatability.

Soybean-derived food materials of the present invention may either be used, as is, within processed foods, or may also be dried to form powders, or sterilized and stored.

A soybean-derived food material according to the first aspect of the present invention enables the production of a novel food material which has little odor, is very palatable, and appears completely unrelated to okara, thus providing a new taste that would have been unthinkable on the basis of conventional okara.

The second aspect of the present invention relates to a method of manufacturing a very low odor soybean-derived food material from soybeans.

The first step in this second aspect of the present invention is a swelling step of swelling the soybeans. In order to swell the soybeans, they are typically immersed in a 5 to 6-fold weight excess of water (with a water temperature of 15 to 25° C.) for a period of 10 to 15 hours. The length of the immersion varies depending on the atmospheric temperature, and the immersion time should be lengthened for cooler water temperatures, to ensure satisfactory swelling. Following confirmation that swelling has progressed satisfactorily, the excess water is removed, and the soybeans are washed and transferred to the subsequent water addition step.

The water addition step involves adding a 2 to 3-fold weight excess of water to the swollen soybeans.

The boiling step is a step of boiling the swollen soybeans in the added water. The boiling may be conducted either at normal pressure, or under pressurized conditions. Boiling should be continued until the swollen soybeans soften, which typically involves boiling the soybeans for 5 to 20 minutes once the water reaches boiling point. Following boiling, the hot water is discarded, and the beans are cooled and transferred to the subsequent mashing step.

The mashing step is a step of mashing the boiled and softened soybeans to form a paste. Examples of suitable devices for conducting the mashing include a millstone or an electric grinder.

The paste produced by the mashing step comprises finely ground particles of the entire soybean, including the husk. In order to achieve a more palatable paste, the mashing technique described below may be employed.

Namely, the hot water is discarded from the boiled soybeans, a 3 to 5-fold weight excess of water is added, and the soybeans are ground coarsely using a first stage grinder. The coarsely ground soybeans may then be ground down to fine particles of 20 to 50 microns using a second stage grinder. Suitable examples of the grinders used at the first and second stages include millstones and electric grinders.

By washing the paste, an odorless soybean-derived food material can be obtained. An example of a suitable washing method involves simply exposing the separated paste to cold or warm water for a period of 1 to 2 hours.

The washed paste may be used, as is, as a food material, dewatered a certain amount (down to a water content of 70 to 90%), dried and powdered, or sterilized and stored.

A soybean-derived food material produced by either the first or second aspect of the present invention has very little odor, and displays good palatability, and can consequently be used as an ingredient in all manner of processed foods. Examples of suitable processed foods include bean jam, bread, cakes, ice cream, processed foods containing bean jam (such as bread, Japanese confectionary, and sweet bean jelly), jelly products, boiled fish-paste products, frozen or retorted foods (such as dumplings and croquettes), cream sauces, and yoghurt drinks, although this is in no way an exhaustive list. Because a soybean-derived food material of the present invention contains the various active ingredients derived from the soybeans, processed foods containing soybean-derived food materials of the present invention are useful as health foods for maintaining or promoting good health.

### EXAMPLES

### Example 1

15000 parts by weight of water was added to 3000 parts by weight of okara, and the water-added okara was boiled. Boiling was continued for 5 minutes after the boiling point was reached, and the mixture was then strained through a filtering cloth to reduce the water content to approximately 90%. A further 9000 parts by weight of water was then added, and the okara was washed. This washing process was repeated 3 times. The water was then discarded and the okara water content was returned to approximately 90%. An additional 3000 parts of water were then added to the okara, and the mixture was stirred well, and then ground to a particle size of 40 microns using an electric grinder (an Atomizer MKA-5J, 10 horsepower, manufactured by Masuko Sangyo Co., Ltd.), thus yielding a paste-like food material.

The water content of the thus formed paste-like food material was reduced to 85%, and the material was then placed in a plastic bag and sterilized by heating, thus yielding a material for refrigerated or frozen foods.

Furthermore, another sample of the boiled and washed okara was dewatered down to a water content of approximately 80% using a filter press, was then further dried with a dryer to reduce the water content to approximately 20%, and was then crushed using a grinder (an Atomizer MKCA10-20 for dry materials, 20 horsepower, manufactured by Masuko Sangyo Co., Ltd.), yielding a finely powdered food material with a particle size of 40 microns.

The food materials produced in this manner displayed almost no distinctive soybean or okara odor.

### Example 2

300 parts by weight of white hilum soybeans were washed thoroughly with water, and were then immersed in 600 parts by weight of water at 20° C. for a period of 13 hours. The water was then discarded, and the soybeans were washed under running water, and then combined with 600 parts by weight of water and boiled. Once the water had boiled, the soybeans were boiled vigorously for 10 minutes, and then simmered on a low heat for a further 20 minutes, leaving the soybeans soft enough to crush between the fingers. Following boiling, the hot water was discarded, and the soybeans were mashed. This mashing step was conducted in two stages using an electric grinder. The first stage was a coarse grinding step in which the boiled beans were combined with 600 parts by weight of water and ground coarsely. In the second stage, an electric grinder (an Atomizer MKA-5J, manufactured by Masuko Sangyo Co., Ltd.) was used to grind the coarse mixture down to a paste-like consistency with a particle size of 40 microns and a water content of approximately 90%, thus forming a food material. This method yielded 550 parts by weight of a paste-like product. Furthermore, forced drying of this 550 parts by weight of paste-like product yielded 290 parts by weight of a finely powdered product.

The food materials produced in this manner displayed almost no distinctive soybean or okara odor.

### Example 3

200 parts by weight samples of the paste-like products obtained in the examples 1 and 2 were each placed in a pot, 30 parts by weight of sugar was added to each pot, and each mixture was boiled gently, with stirring, on a low heat to prevent burning, thus yielding approximately 200 parts by weight of suitably firm bean jam. The bean jams produced using the paste-like products obtained in the examples 1 and 2 were, with the exception of color, almost indistinguishable from typical commercially available products.

Each of the jams was added to a solution comprising 5 parts by weight of gelatin dissolved in 100 parts by weight of hot water, and was then mixed thoroughly and simmered on a low heat for 5 minutes, before being poured into a molding box and cooled, thus yielding a sweet bean jelly. The sweet bean jellies produced from the jams using the paste-like products obtained in the examples 1 and 2 were, with the exception of color, indistinguishable from typical products.

### Example 4

100 parts by weight samples of the finely powdered products produced in the examples 1 and 2 were each mixed thoroughly with 100 parts by weight of water, forming a paste in each case. Bean jams and sweet bean jellies were then produced in the same manner as the example 3. The bean jams and the sweet bean jellies produced using the powdered products obtained in the examples 1 and 2 were, with the exception of color, indistinguishable from typical products.

### Example 5

30 parts by weight samples of the paste-like products obtained in the examples 1 and 2 were each combined and mixed with 200 parts by weight of milk and 5 parts by weight of a commercially available powdered coffee. Each mixture was then heated to boiling, a solution comprising commercially available jelly (1 packet, 5 g) dissolved in 50 parts by weight of hot water was added, and following thorough stirring, the mixture was placed in a container, cooled, and then cooled further in a refrigerator, thus yielding a jelly-like food product. In the jelly-like foods produced using the paste-like products obtained in the examples 1 and 2, the okara component precipitated out, forming a two-layered product, but the appearance was still favorable, and the taste and texture were also quite satisfying.

### Example 6

With the exception of increasing the quantities of the paste-like products to 200 parts by weight, preparation in the same manner as the example 5 yielded Bavarian cream-like foods. These Bavarian cream-like foods displayed a satisfactory taste and texture.

### Example 7

200 g of mincemeat, 330 g of finely chopped onions, and nine roughly mashed, medium-sized, steamed potatoes were mixed together well. 250 g samples of the mixture were then mixed with 100 g samples of the paste-like products obtained in the examples 1 and 2, and salt and pepper were added. Each mixture was then divided into 4 equal portions, and each portion was molded into an oval shape, coated with flour, egg, and breadcrumbs, and deep fried in vegetable oil at 170° C. These croquettes produced using the paste-like products obtained in the examples 1 and 2 displayed a satisfactory taste and texture.

### Example 8

A single large potato was peeled, cut into 3 mm slices, and heated for approximately 10 minutes in a microwave oven. 75 g of a commercially available gratin sauce, 75 g of the paste-like product from either of the examples 1 and 2, and 50 g of milk were mixed together while being concentrated down. A gratin dish was then coated with butter, the heated potato slices were arranged in the dish, the sauce was poured over the potato, a generous quantity of melting cheese was sprinkled on top, and the gratin was baked for 10 minutes in an oven-toaster. The gratins produced using the paste-like products obtained in the examples 1 and 2 displayed a satisfactory taste and texture, and appeared absolutely no different from normal products.

### Example 9

The croquettes and gratins prepared in the examples 7 and 8 were snap frozen prior to cooking, thus yielding frozen food products.

### Example 10

100 g samples of the paste-like products from the examples 1 and 2 were each added to 450 ml of milk, 1 tablespoon of sugar was added, and each sample was then stirred and heated to boiling, before being cooled to 45° C. 2 teaspoons of commercially available plain yoghurt was then added to each sample and stirred well. The products were then left to stand for 8 hours in a 40° C. constant temperature container, and were then removed and cooled, yielding yoghurt drinks. The yoghurt drinks produced using the paste-like products obtained in the examples 1 and 2 displayed a very pleasing taste and texture.

### INDUSTRIAL APPLICABILITY

The present invention succeeds in providing dramatic improvements in the palatability and texture of okara, enabling the okara to be reused as a completely novel, previously inconceivable food material that retains the nutritional value of the okara.

The present invention as set forth in claim 1 enables the manufacture of a soybean-derived food material with no characteristic soybean odor, using the conventionally discarded okara as a raw material, and because the obtained food material still retains the soybean saponin, isoflavone, soybean lecithin, and dietary fiber and the like derived from the soybeans, it can be used as a health food product or in processed foods. This aspect of the invention also enables the currently discarded okara to be used effectively.

The present invention as set forth in claim 2 enables the manufacture of a soybean-derived food material with no characteristic soybean odor, using soybeans as a raw material, and because the obtained food material still retains the soybean saponin, isoflavone, soybean lecithin, and dietary fiber derived from the soybeans, it can be used as a health food product or in processed foods.

The present invention as set forth in claim 3, in addition to providing the effects described above, also enables the palatability of a soybean-derived food product to be improved, providing a smoother taste.

The present invention as set forth in claim 4 enables the manufacture of a processed food, which although being free from the soybean odor, still retains the soybean saponin, isoflavone, soybean lecithin, and dietary fiber and the like derived from the soybeans.

1. A method of manufacturing a soybean-derived food material, characterized in that water-added okara is boiled, and then washed in either cold or warm water.

2. A method of manufacturing a soybean-derived food material, characterized by comprising a swelling step of immersing soybeans in water to swell the soybeans, a water addition step of adding water to the swollen soybeans, a boiling step of boiling the swollen soybeans in the added water, a mashing step of mashing the boiled soybeans, and a washing step of washing the paste produced from the mashed soybeans.

3. The method of manufacturing a soybean-derived food material according to claim 1, wherein the soybean-derived food material is formed as fine particles of 20 to 50 microns.

4. A processed food comprising a soybean-derived food material manufactured by the method according to claim 1.

5. The method of manufacturing a soybean-derived food material according to claim 2, wherein the soybean-derived food material is formed as fine particles of 20 to 50 microns.

6. A processed food comprising a soybean-derived food material manufactured by the method according to claim 2.

7. A processed food comprising a soybean-derived food material manufactured by the method according to claim 3.

8. A processed food comprising a soybean-derived food material manufactured by the method according to claim 5.
